(19) United States
(12) Patent Application Publication
(10) Pub. No.: US 2024/0279404 A1
(43) Pub. Date: Aug. 22, 2024

(54) POLYCARBONATE WITH CARBOXY END GROUPS AND METHOD FOR PREPARING POLYCARBONATE

(71) Applicant: Covestro Deutschland AG, Leverkusen (DE)

(72) Inventors: Andreas Seidel, Dormagen (DE); Jan Heijl, Lokeren (BE); Annabelle Bertin, Antwerpen (BE)

(21) Appl. No.: 18/576,137

(22) PCT Filed: Jun. 27, 2022
(86) PCT No.: PCT/EP2022/067472

§ 371 Date: Jan. 3, 2024

(30) Foreign Application Priority Data
Jul. 5, 2021 (EP) 21183770.3

(51) Int. Cl. C08G 81/02; C08G 64/14; C08G 64/24; C08G 85/00

(52) U.S. Cl. CPC C08G 81/027; C08G 64/14; C08G 64/24; C08G 85/004

(57) ABSTRACT

The present invention relates to an aromatic polycarbonate containing: A) structural units with free COOH functionality which are derived from a hydroxybenzoic acid and are present as end groups, and B) structural units derived from a hydroxybenzoic acid, wherein component B) is chosen from at least one representative from B1) structural units with esterified COOH functionality which are derived from a hydroxybenzoic acid and are present as end groups, and B2) structural units derived from a hydroxybenzoic acid which are incorporated into the polymer chain via an ester or acid anhydride group, wherein the molar ratio of the quantity of component A to the quantity of component B ranges from 1.3 to 50, as well as copolymers and thermoplastic moulding compounds and moulds containing such a polycarbonate or copolymer, a method for preparing the polycarbonate and a method and use of the polycarbonate to prepare the copolymers.

The present invention relates to an aromatic polycarbonate with carboxy end groups, to a process for producing an aromatic polycarbonate, to the use of the aromatic polycarbonate for producing copolymers, to a process for producing the copolymers and to a moulding compound and a shaped article containing the copolymers.

Polycarbonate has been used for many years for producing transparent or translucent (transilluminable) shaped articles. The automotive sector, the construction sector and the electronics sector have in recent years gained applications with novel illumination concepts and function integration which employ transilluminable moulding compounds.

However, for some applications polycarbonate is inadequate in terms of important properties such as for example scratch resistance, stress cracking resistance under the influence of chemicals, mechanical properties and processing characteristics (melt flowability). The development of polymer blends of polycarbonate with other thermoplastics is an often used approach to realize specific technical demand profiles through combination of the specific advantageous properties of polycarbonate with those of the polymeric blend partners, ideally in a synergistic fashion. Polymer blends of polycarbonate (PC) and polymethyl methacrylate (PMMA) may for example exhibit improvements over pure polycarbonate in terms of scratch resistance, stress cracking resistance under the influence of chemicals and melt flowability. Material ductility may simultaneously be increased relative to polymethyl methacrylate.

However, the advantageous combinations of properties which can be achieved with such polymer blends often preclude a transparency/transilluminability of shaped articles produced therefrom. Polycarbonate and the further thermoplastic present in the polymer blend are generally incompletely miscible and therefore form biphasic morphologies with a matrix phase of one polymer and domains of the other polymers distributed therein. Due to the typically different refraction indices of the blend partners light scattering occurs at the multiplicity of phase interfaces and light transmittance is thus altogether considerably reduced compared to that of the pure blend components. Such blends of polycarbonate and polycarbonate-immiscible polymers are thus generally opaque, i.e. not transilluminable or transilluminable only with an inadequate light yield.

The phase interfaces may moreover constitute mechanical weak points and, especially under the influence of chemicals, lead to material failure.

One option described in the literature for achieving improved compatibility of polycarbonate with a PC-immiscible thermoplastic blend partner such as for example PMMA is in situ formation of block copolymers from polycarbonate and the polymeric blend partner, i.e. in this specific case PMMA, in a reactive extrusion. The chemical reaction of the two polymers at the phase interface of the biphasic melt mixture may be accelerated through the use of a catalyst.

WO 2020/212229 A1 discloses a reactive compounding process for producing a thermoplastic moulding compound using aromatic polycarbonate containing no reactive functional groups and a further polymer which contains at least one type of functional groups selected from ester, epoxy, hydroxy, carboxy and carboxylic anhydride groups, wherein the catalyst employed is a special phosphonium salt. The application especially also discloses the production of transparent thermoplastic PC/PMMA moulding compounds in such a process.

WO 2016/138246 A1 discloses transparent PC/PMMA blends containing 9.9% to 40% by weight of polycarbonate and 59.9% to 90% by weight of PMMA which are produced from non-reactively functionalized polymer components in a reactive melt extrusion using 0.0025 to 0.1% by weight of a tin catalyst.

WO 2016/189494 A1 discloses transparent PC/PMMA blends containing 80% to 95% by weight of a specifically specified branched polycarbonate having an end cap content of 45% to 80% and 4.9% to 20% by weight of PMMA which are produced in a melt extrusion by transesterification using 0.1% to 1.5% by weight of a catalyst, preferably selected from Zn, Sn and Ag compounds.

Moulded parts made of blend compositions produced by these processes are improved in terms of light transmittance relative to moulded parts made of PC/PMMA compositions produced by purely physical mixing processes but generally have a light yield upon transillumination which is not yet adequate for many applications and inadequate mechanical properties, in particular an insufficient material ductility.

In addition to the described use of a catalyst a suitable functionalization of the polycarbonate can likewise favour the in situ formation of copolymers.

U.S. Pat. Nos. 4,853,458 and 4,959,411 describe the production of terminally carboxy-functionalized polycarbonates, wherein a carboxylic acid- or carboxylic acid derivative-substituted phenol, preferably t-butyl p-hydroxybenzoate, is terminally incorporated into the PC as chain terminator in a polycarbonate-forming reaction. Also disclosed is a process for producing a block copolymer by reaction in organic solution or in a melt compounding of an epoxy-functionalized olefin polymer with such a carboxy- or carboxylic acid derivative-functionalized polycarbonate and to the use of such a copolymer for compatibilizing polymer blends of polycarbonate and polyolefin with the objective of reducing their tendency to delamination. These applications give no pointers to the suitability of polycarbonates functionalized in this way for producing transparent PC/PMMA blends.

For the latter approach to a reaction between a suitably functionalized polycarbonate and the polymeric blend partner the precise type of the functionalization of the polycarbonate, i.e. the selection and concentration of suitable reactive groups, is of great importance, as is an efficient process for production thereof. The moulding compound produced from the polycarbonate and the blend partner shall moreover be suitable for the thermoplastic processing to afford shaped articles. There was still a need for improvement of these aspects having regard to the prior art.

It was thus desirable to provide an aromatic polycarbonate which is particularly suitable for producing block copolymers containing at least one polycarbonate block which are suitable as compatibilizers in polymer blends for example.

It was especially desirable to provide an aromatic polycarbonate which is particularly suitable for producing thermoplastic transilluminable moulding compounds and shaped articles containing polycarbonate and a vinyl polymer, preferably polymethyl methacrylate.

It was likewise desirable to provide a process by which the functionalized polycarbonate is produced easily and with an advantageous ratio to undesired byproducts.

It has now been found that, surprisingly, the desired properties are exhibited by an aromatic polycarbonate containing
A) structural units having a free COOH functionality derived from a hydroxybenzoic acid and present as end groups and
B) structural units derived from a hydroxybenzoic acid,
wherein component B) is selected from at least one representative of
B1) structural units having an esterified COOH functionality derived from a hydroxybenzoic acid and present as end groups
and
B2) structural units derived from a hydroxybenzoic acid which are incorporated in the polymer chain via an ester group (=B2-a) or acid anhydride group (=B2-b),
wherein the molar ratio of the amount of component A to the amount of component B is in the range from 1.3 to 50.

In a preferred embodiment the polycarbonate further contains as component C structural units derived from monophenols (i.e. aromatics having only one phenolic OH functionality) containing no carboxy or carboxy derivative functionalities as end groups.

It is further preferable when component C is present in the polycarbonate according to the invention in a molar proportion, based on a total of 100 mol % of the molar proportions of components A, B1, B2 and C, of 20 to 90 mol %, particularly preferably 40 to 85 mol %, more preferably 45 to 80 mol %, particularly preferably 50 to 75 mol %.

In the context of the present application the terms “carboxy” and “carboxyl” are used synonymously and represent COOH groups.

The aromatic polycarbonate according to the invention is hereinbelow referred to as aromatic polycarbonate containing (terminal) COOH end groups.

It has likewise been found that, surprisingly, such an aromatic polycarbonate may be produced by a process comprising the steps of:
(i) producing an aromatic polycarbonate containing end groups derived from a hydroxybenzoic ester by phosgenation in the phase interface process or in organic solution of aromatic diols in the presence of an ester of a hydroxybenzoic acid (preferably p-hydroxybenzoic acid) or a mixture of two or more esters of one or more structurally distinct hydroxybenzoic acids, more preferably esterified with an alcohol of general structural formula (1)

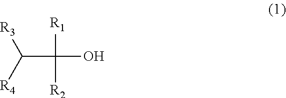

wherein R₁ and R₂ independently of one another represent hydrogen or an alkyl, aryl or alkylaryl radical having 1 to 10 carbon atoms, preferably hydrogen or an alkyl radical having 1 to 4 carbon atoms, particularly preferably hydrogen or a methyl radical, most preferably both represent a methyl radical, and
R₃ and R₄ independently of one another represent hydrogen or an alkyl, aryl or alkylaryl radical having 1 to 10 carbon atoms, preferably hydrogen or an alkyl radical having 1 to 4 carbon atoms, particularly preferably hydrogen or a methyl radical, most preferably both represent hydrogen,
as chain terminator,
wherein a temperature of 260° C., preferably a temperature of 240° C., more preferably a temperature of 230° C., most preferably a temperature of 200° C., is at no point exceeded in the producing according to process step (i), and
(ii) thermal end group pyrolysis of the hydroxybenzoic ester-derived end groups in the product from process step (i) to eliminate an alkene of general structural formula R₃R₄C═CR₁R₂,
wherein R₁, R₂, R₃ and R₄ are as defined above,
wherein in process step (ii) the product from process step (i) is pyrolysed in the temperature range 230° C. to 265° C., preferably 230° C. to 260° C., particularly preferably 230° C. to 255° C., by supplying thermal or mechanical energy and the resulting alkene is removed from the apparatus and
wherein the residence time at the temperature in the range 230° C. to 265° C., preferably 230° C. to 260° C., particularly preferably 230° C. to 255° C., is not less than 15 seconds and not more than 10 minutes, preferably not less than 20 seconds and not more than 5 minutes, particularly preferably not less than 30 seconds and not more than 2 minutes.

The alcohol with which the hydroxybenzoic acid is esterified is preferably a tertiary alcohol, most preferably tert-butanol.

It has been found that, surprisingly, polycarbonates having the structural features according to the invention required for solving the technical problem are not obtained in case of noncompliance with the abovementioned temperature and residence time conditions.

In a preferred embodiment the process step (ii) is performed in a compounding apparatus selected from the group comprising single-screw extruders, co-rotating or counter-rotating twin-screw extruders, planetary roller extruders, continuous or discontinuous internal kneaders and filmtruders, wherein in process step (ii) the product from process step (i) is melted in these compounding apparatuses by supplying thermal or mechanical energy and pyrolysed at a melt temperature in the temperature range 230° C. to 265° C., preferably 230° C. to 260° C., particularly preferably 230° C. to 255° C., and the resulting alkene is removed from the apparatus and wherein the residence time at the temperature in the range of 230° C. to 265° C., preferably 230° C. to 260° C., particularly preferably 230° C. to 255° C., is not less than 15 seconds and not more than 10 minutes, preferably not less than 20 seconds and not more than 5 minutes, particularly preferably not less than 30 seconds and not more than 2 minutes. In this preferred embodiment preferably before use in process step (ii) the aromatic polycarbonate produced in process step (i), after the
(i-a) polymerization by phosgenation in the phase interface process or in organic solution of aromatic diols in the presence of an ester of a hydroxybenzoic acid, is
(i-b) isolated in a downstream workup step, i.e. the solvent or solvent mixture used in process step (i-a) is at least largely separated.

Both in the polymerization process step (i-a) and in the workup step (i-b) the temperature at no point exceeds a temperature of 260° C., preferably at no point exceeds a temperature of 240° C., more preferably at no point exceeds a temperature of 230° C., most preferably at no point exceeds a temperature of 200° C.

The workup according to step (i-b) is especially carried out by spray drying or by precipitation of the polycarbonate in a suitable solvent, for example in isopropanol, methanol or water, with subsequent separation of the solvent phase. This separation may for example be effected by filtration, sedimentation with subsequent decanting, centrifugation or a combination of these processes, in each case with subsequent drying, wherein the drying is preferably carried out at temperatures in the range 60° C. to 120° C., particularly preferably with application of negative pressure.

In an alternative, likewise preferred process, process step (ii) may also be carried out in the context of the isolation of the polycarbonate from process step (i), i.e. for example in the context of the removal of (residual) solvent. In this case the solvent/solvent mixture or after partial removal of the solvent/solvent mixture in a process step (i-b) the residual solvent or solvent mixture is in process step (ii) removed by supplying thermal or mechanical energy in the temperature range 230° C. to 265° C., preferably 230° C. to 260° C., particularly preferably 230° C. to 255° C., optionally with application of negative pressure while simultaneously the end groups derived from a hydroxybenzoic ester are thermally pyrolysed and the resulting alkene is likewise removed from the apparatus, wherein the residence time at the temperature in the range 230° C. to 265° C., preferably 230° C. to 260° C., particularly preferably 230° C. to 255° C., is not less than 15 seconds and not more than 10 minutes, preferably not less than 20 seconds and not more than 5 minutes, particularly preferably not less than 30 seconds and not more than 2 minutes. Process apparatuses suitable for such a process according to the invention preferably include those selected from the group consisting of degassing extruder, strand evaporator, filmtruder and foam evaporator.

### Aromatic Polycarbonate

The aromatic polycarbonate according to the invention contains
A) structural units having a free COOH functionality derived from a hydroxybenzoic acid and present as end groups (also referred to as COOH or synonymously carboxy or carboxyl end groups) and
B) structural units derived from a hydroxybenzoic acid, wherein component B) is selected from at least one representative of
B1) structural units having an esterified COOH functionality derived from a hydroxybenzoic acid and present as end groups
and
B2) structural units derived from a hydroxybenzoic acid which are incorporated in the polymer chain via an ester group (=B2-a) or acid anhydride group (=B2-b),
   and is characterized in that the molar ratio of the amounts of components A and B is in the range 1.3 to 50, preferably in the range 1.5 to 25, particularly preferably in the range 1.8 to 10, most preferably in the range 2.0 to 5.0.

When calculating the molar ratio of the amounts of components A and B the employed molar amount of component B is the sum of the molar amounts of components B1, B2-a and B2-b.

The polycarbonates according to the invention preferably have an acid number of at least 0.3 mg potassium hydroxide (KOH)/g, more preferably at least 0.5 mg potassium hydroxide (KOH)/g, more preferably at least 1.0 mg KOH/g, most preferably at least 1.5 KOH/g, in each case determined in dichloromethane (DCM)/ethanol as solvent according to DIN EN ISO 2114, method A, 2002-6 version, by potentiometric titration with ethanolic KOH solution at room temperature.

The polycarbonates according to the invention preferably have an acid number in the range from 0.5 to 10 mg potassium hydroxide (KOH)/g, more preferably 1 to 7 mg KOH/g, particularly preferably 1.3 to 5.0 mg KOH/g, most preferably 1.5 to 3.5 mg KOH/g, in each case determined in dichloromethane (DCM)/ethanol as solvent according to DIN EN ISO 2114, method A, 2002-6 version, by potentiometric titration with ethanolic KOH solution at room temperature.

For determination of the acid number the polymer to be investigated is dissolved in a concentration of 10 g/L in 50 mL of dichloromethane at room temperature. 5 mL of ethanol are added to the sample solution before the potentiometric titration with 0.1 N ethanolic KOH.

In a preferred embodiment the polycarbonate is characterized in that the molar ratio of the amount of component B2 to the sum of the amounts of components A and B2 is <0.3, preferably <0.2. When calculating this molar ratio the employed molar amount of component B2 is the sum of the molar amounts of components B2-a and B2-b.

In a further preferred embodiment the polycarbonate is characterized in that therein the molar ratio of the amount of component A to the sum of the amounts of components A and B1 is >0.75, preferably >0.9.

Contemplated hydroxybenzoic acids include hydroxybenzoic acids having the carboxylic acid group para, meta or ortho to the phenolic OH group. Hydroxybenzoic acids having the carboxylic acid group para to the phenolic OH group are preferred. These may be mono- or polysubstituted at the free aromatic ring positions with C₁-C₁₀ alkyl, aryl or alkylaryl radicals, preferably with C₁-C₄ alkyl radicals, particularly preferably with methyl, or alternatively with halogen or ether groups, for example and preferably with methoxy.

The structural units derived from a hydroxybenzoic acid are particularly preferably structural units derived from p-hydroxybenzoic acid containing no further substituents.

The structural units having an esterified COOH functionality derived from a hydroxybenzoic acid and present as end groups according to component B1 are preferably esters of a hydroxybenzoic acid (preferably p-hydroxybenzoic acid), more preferably esterified with an alcohol of the abovementioned structural formula (1).

The alcohol is preferably a tertiary alcohol, most preferably tert-butanol.

The structures for the components A, B1 and B2 are represented by way of example in the formulae (2), (3), (4a) and (4b) for the p-hydroxybenzoic acid particularly preferred as the hydroxybenzoic acid, wherein formula (2) represents component A, formula (3) represents component B1 (for the example of the particularly preferred tert-butyl ester) and formulae (4a) and (4b) represent component B2. Formula (4a) shows the structural unit derived from a hydroxybenzoic acid which is incorporated in the polymer chain via an ester group (component B2-a). Formula (4b) shows the structural unit derived from a hydroxybenzoic acid which is incorporated in the polymer chain via an acid anhydride group (component B2-b).

In the formulae (2), (3), (4a) and (4b) m and n each represent the number of the monomer units shown in the brackets.

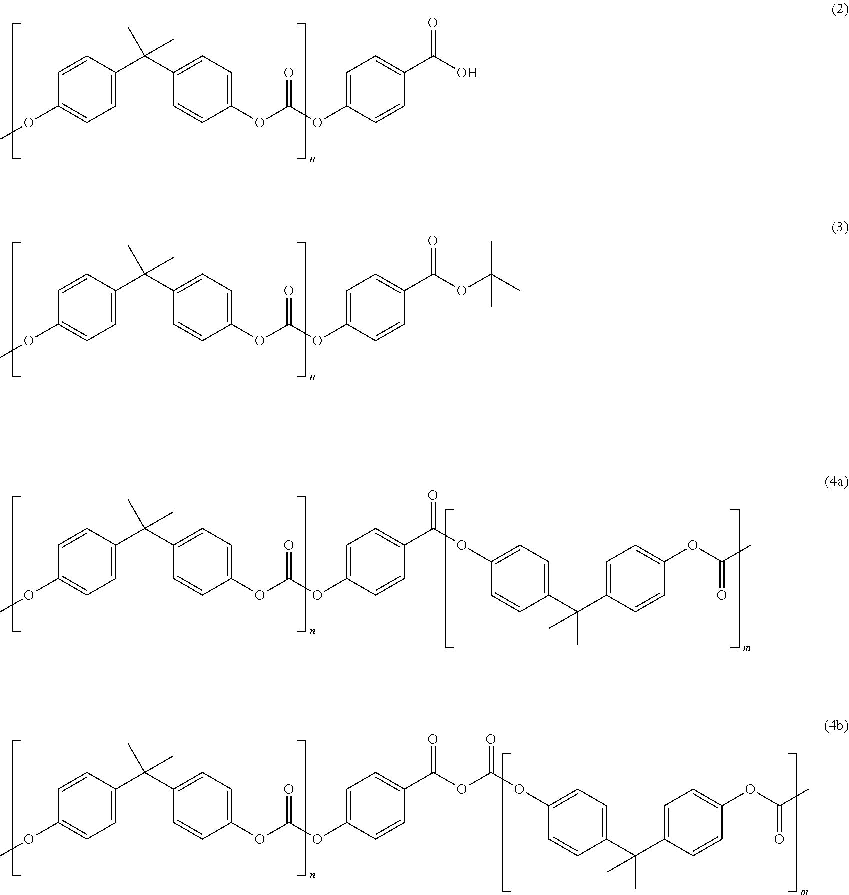

The molar proportion of components A and B1 and of the two possible structures for component B2, and the corresponding molar ratios of these components relevant for the invention are determined by ¹H NMR spectroscopy. To this end the polycarbonate is dissolved in deuterated chloroform at room temperature. The different structural units derived from a hydroxybenzoic acid may be distinguished via the NMR signals of the aromatic protons ortho to the carboxy functionality/to the derivatized carboxy functionality and the molar amounts/ratios of the different structures may be quantified on the basis of the integrated intensities of these signals. In the case of the particularly preferred p-hydroxybenzoic acid the spin-spin coupling of the ortho aromatic protons with the aromatic protons meta to the carboxy functionality/to the derivatized carboxy functionality means that doublets are concerned in all cases. For all components A, B1 and B2 the corresponding NMR signals are each attributable to two protons and therefore the ratios of the intensities of the corresponding NMR signals allow direct derivation of the corresponding molar ratio of the proportions of the different components in the polycarbonate.

In the special case of the particularly preferred p-hydroxybenzoic acid
the protons in the structural units derived from p-hydroxybenzoic acid according to component A resonate in the range of around 8.14 ppm,
the protons in the structural units derived from p-hydroxybenzoic acid according to component B1 in the case of the tert-butyl ester according to formula (2) resonate in the range of around 8.05 ppm,
the protons in the structural units derived from p-hydroxybenzoic acid according to component B2-b (formula 4b) which are incorporated in the polymer chain via an acid anhydride group resonate in the range of around 8.22 ppm and
the protons in the structural units derived from p-hydroxybenzoic acid according to component B2-a (formula 4a) which are incorporated in the polymer chain via an ester group resonate in the range of around 8.26 ppm,
wherein all chemical shifts are reported in “parts per million” (ppm) relative to trimethylsilane (TMS) as the reference.

Accordingly, preferred polycarbonates, which for the hydroxybenzoic acid-derived structural units according to components A, B1 and B2 are in all cases p-hydroxybenzoic acid-derived structural units and for the structural units having an esterified COOH functionality derived from a hydroxybenzoic acid and present as end groups according to component B1 are structural units derived from tert-butyl 4-hydroxybenzoate according to formula (2), have the feature that in their ¹H NMR spectrum measured in a solution of the polycarbonate in deuterated chloroform at room temperature the ratio of the integrated intensity of the doublet signal in the range of around 8.14 ppm to the sum of the integrated intensities of the doublet signals in the ranges of around 8.05 ppm, 8.22 ppm and 8.26 ppm is in the range 1.3 to 50, preferably in the range 1.5 to 25, particularly preferably in the range 1.8 to 10, most preferably in the range 2.0 to 5.0, wherein the chemical shifts are in each case referenced against tetramethylsilane (TMS).

In an alternative embodiment this ratio is in the range 3 to 50, preferably in the range 3 to 25, most preferably in the range 3 to 10.

These preferred polycarbonates particularly preferably also have the additional feature that in their ¹H NMR spectrum measured in a solution of the polycarbonate in deuterated chloroform at room temperature the ratio of the sum of the integrated intensities of the doublet signals in the ranges of around 8.22 ppm and 8.26 ppm to the sum of the integrated intensities of the doublet signals in the ranges of around 8.14 ppm, 8.22 ppm and 8.26 ppm is <0.3, preferably <0.2, wherein the chemical shifts are in each case referenced against tetramethylsilane (TMS).

These preferred polycarbonates particularly preferably also have the additional feature that in their ¹H NMR spectrum measured in a solution of the polycarbonate in deuterated chloroform at room temperature the ratio of the sum of the integrated intensity of the doublet signal in the range of around 8.14 ppm to the sum of the integrated intensities of the doublet signals in the ranges of around 8.14 ppm and 8.05 ppm is >0.75, preferably >0.9, wherein the chemical shifts are in each case referenced against tetramethylsilane (TMS).

In a preferred embodiment the polycarbonate further contains as component C structural units derived from monophenols (i.e. aromatics having only one phenolic OH functionality) containing no carboxy or carboxy derivative functionalities as end groups. The monophenols from which component C is derived are preferably phenol or alkyl-, aryl-, alkylaryl- and/or halogen-substituted phenols, particularly preferably phenol or C₁-to C₁₂-alkylphenols, more preferably phenol or p-tert-butylphenol, most preferably p-tert-butylphenol.

It is further possible to employ for example p-chlorophenol, 2,4,6-tribromophenol, 4-(2,4,4-trimethylpentyl)phenol, 4-(1,1,3,3-tetramethylbutyl)phenol, 3,5-di-tert-butylphenol, p-isooctylphenol, p-tert-octylphenol, p-dodecylphenol and 4-(3,6-dimethyl-3-heptyl)phenol.

In a preferred embodiment the monophenols mentioned here containing no carboxy or carboxy derivative functionalities are employed as further chain terminators in the production of the polycarbonate according to the invention.

It is also possible to employ mixtures of two or more monophenolic chain terminators containing no carboxy or carboxy derivative functionalities.

It is further preferable when component C is present in the polycarbonate according to the invention in a molar proportion, based on a total of 100 mol % of the molar proportions of components A, B1, B2, i.e. the sum of the molar proportions of B2-a and B2-b, and C, of 20 to 90 mol %, particularly preferably 40 to 85 mol %, more preferably 45 to 80 mol %, particularly preferably 50 to 75 mol %.

These proportions on the one hand make it possible to achieve a sufficient copolymer formation of polycarbonate and the blend partner while on the other hand avoiding undesired crosslinking reactions as set out again below.

Also the amount of component C in the polycarbonate and the molar proportion thereof based on a total of 100 mol % of the molar proportions of components A, B1, B2 and C may be spectroscopically quantified by ¹H NMR. In the particularly preferred case in which component C are structural units derived from p-tert-butylphenol the NMR signal of the three methyl groups in the tert-butyl radical in the structural units derived from p-tert-butylphenol is for example particularly suitable therefor. This is a singlet at a chemical shift in the range of around 1.32 ppm referenced against trimethylsilane which is assigned to nine protons.

The polycarbonates according to the invention may also contain
as component A a plurality of structural units having a free COOH functionality derived from structurally distinct hydroxybenzoic acids and present as end groups,
as component B1 a plurality of different structural units having an esterified COOH functionality and present as end groups which are distinguishable both in terms of the structural nature of the hydroxybenzoic acid and in terms of the structural nature of the tertiary alcohol employed to form the ester,
as component B2 a plurality of structural units derived from structurally distinct hydroxybenzoic acids which are incorporated in the polymer chain via an ester or acid anhydride group,
and/or
as component C a plurality of structural units derived from structurally distinct hydroxybenzoic acids containing no carboxy or carboxy derivative functionalities as end groups.

It is then the case that for all quantity ratio ranges of these structural units recited in the present application the molar amounts of the components A, B1, B2 and C used to calculate the corresponding ratios are in each case the sum of all molar amounts of the structurally distinct components A, B1, B2 and C.

The polycarbonate preferably has a weight-average molecular weight M_{w}, measured by GPC (gel permeation chromatography) at room temperature in methylene chloride using a BPA polycarbonate standard, of 5 000 to 40 000 g/mol, more preferably of 7000 to 35 000 g/mol, particularly preferably of 10 000 to 30 000 g/mol.

For the use of the polycarbonate according to the invention as the moulding compound for producing moulded parts or as a constituent of a moulding compound for producing moulded parts the polycarbonate according to the invention preferably has a weight-average molecular weight M_{w}, measured by GPC (gel permeation chromatography) at room temperature in methylene chloride using a BPA polycarbonate standard, of 18 000 to 40 000 g/mol, more preferably of 20 000 to 35 000 g/mol, particularly preferably of 24 000 to 32 000 g/mol.

For the use of the polycarbonate according to the invention to produce block copolymers containing blocks of aromatic polycarbonate and blocks of a polymer immiscible with such aromatic polycarbonates it may be advantageous and preferable with regard to the efficiency of these block copolymers as compatibilizers in thermoplastic polymer compositions containing aromatic polycarbonate and such polymers immiscible with aromatic polycarbonate to employ a polycarbonate according to the invention having a weight-average molecular weight M_{w}, measured by GPC (gel permeation chromatography) at room temperature in methylene chloride using a BPA polycarbonate standard, of 5000 to 25 000 g/mol, more preferably of 7000 to 20 000 g/mol, particularly preferably of 8000 to 18 000 g/mol, most preferably of 10 000 to 15 000 g/mol.

When employing a mixture of two or more polycarbonates having different individual acid numbers, a different ratio of A/B, a different ratio of B2/(A+B2), a different ratio of A/(A+B1) and/or different individual weight-average molecular weights M_{w}, this mixture has an acid number, a ratio of A/B, a ratio of B2/(A+B2), a ratio of A/(A+B1) and a weight-average molecular weight M_{w} in one of the abovementioned ranges.

Production of aromatic polycarbonates in general is known from the literature (for production of aromatic polycarbonates see for example Schnell, “Chemistry and Physics of Polycarbonates”, Interscience Publishers, 1964).

Production of the aromatic polycarbonates according to the invention containing terminal COOH groups is carried out in similar fashion to U.S. Pat. No. 4,853,458 B by reaction of diphenols (aromatic diols) with phosgene by the phase interface process using an ester of a hydroxybenzoic acid as described above or a mixture of two or more esters or a mixture of two or more structurally distinct hydroxybenzoic acids, wherein when such a mixture is used the employed esters may differ both in terms of the nature of the hydroxybenzoic acid and in terms of the nature of the alcohol used to form the ester, as monophenolic chain terminators and subsequent liberation of the terminal COOH groups (COOH functionality).

In a preferred embodiment the above-described further monophenols containing no carboxy or carboxy derivative functionalities are employed as chain terminators in addition to the ester of a hydroxybenzoic acid.

When such further monophenolic chain terminators containing no carboxy or carboxy derivative functionalities are employed the produced aromatic polycarbonate contains not only the components A, B1 and B2 but also structural units derived from the monophenolic chain terminators, most preferably derived from p-tert-butylphenol, as component C.

When producing the polycarbonates according to the invention the monophenolic chain terminators containing no carboxy or carboxy derivative functionalities are preferably employed in the chain terminator mixture consisting of these monophenolic chain terminators containing no carboxy or carboxy derivative functionalities and the esters of a hydroxybenzoic acid employed as chain terminator in a proportion of 20 to 90 mol %, particularly preferably 40 to 85 mol %, more preferably 45 to 80 mol %, most preferably 50 to 75 mol %. The resulting difference in each case to 100 mol % then corresponds to the proportion of the esters of one or more hydroxybenzoic acids. This difference is thus preferably 10 to 80 mol %, particularly preferably 15 to 60 mol %, more preferably 20 to 55 mol %, most preferably 25 to 50 mol %.

If the content of esters of a hydroxybenzoic acid employed in the chain terminator mixture is greater than the specified preferred ranges, use of the polycarbonates can result in undesired crosslinking reactions during reactive compounding with the blend partner with the result that the thermoplastic processability of the reactive mixture is no longer ensured. If the content of esters of a hydroxybenzoic acid employed in the chain terminator mixture is lower than the specified preferred ranges, the desired copolymer formation between the polycarbonate and the blend partner can no longer occur to a sufficient extent to achieve the desired technical effect.

The molecular weight of the thus-produced polycarbonates is specifically adjustable over wide ranges in a manner familiar to those skilled in the art through variation of the ratio of the monophenolic chain terminator to diphenols.

The content of COOH groups in the aromatic polycarbonate is specifically adjustable over wide ranges through the usage amount ratio in the chain terminator mixture of the hydroxybenzoic ester to the optionally employed monophenolic chain terminators containing no carboxy or carboxy derivative functionalities and through the conditions in the subsequent liberation of the COOH groups.

The terminal COOH groups (i.e. hydroxybenzoic acid end groups) may be liberated from the polycarbonates having hydroxybenzoic ester end groups for example through thermal end group pyrolysis or through acidic ester cleavage.

A preferred process for liberating the terminal COOH groups is thermal end group pyrolysis. The temperatures employed are preferably 230° C. to 265° C., particularly preferably 230° C. to 260° C., most preferably 230° C. to 255° C. The residence times at these temperatures are not less than 15 seconds and not more than 10 minutes, preferably not less than 20 seconds and not more than 5 minutes, particularly preferably not less than 30 seconds and not more than 2 minutes. Under these thermal conditions the polycarbonate backbone is not appreciably degenerated and undesired side reactions are minimized. Varying in particular the temperature but also the residence time at this temperature makes it possible to control the proportion of the COOH end groups liberated from component B1 according to component A and also the ratio to undesired secondary/downstream products according to component B2. Component C remains generally unaffected in the thermal end group pyrolysis.

Diphenols for production of the aromatic polycarbonates and/or aromatic polyester carbonates are preferably those of formula (5)

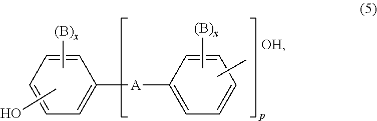

where
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, onto which further aromatic rings optionally containing heteroatoms may be fused,
   or a radical of formula (6) or (7)

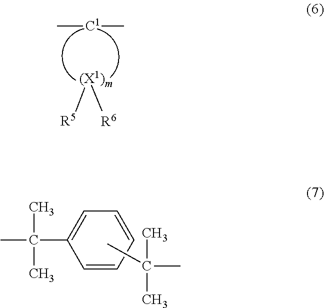

B is in each case C₁ to C₁₂ alkyl, preferably methyl, halogen, preferably chlorine and/or bromine,
x is in each case independently 0, 1 or 2,
p is 1 or 0, and
R⁵ and R⁶ can be selected individually for each X¹ and are each independently hydrogen or C₁ to C₆ alkyl, preferably hydrogen, methyl or ethyl,
X¹ is carbon and
m is an integer from 4 to 7, preferably 4 or 5, with the proviso that, on at least one atom X¹, R⁵ and R⁶ are both alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and also the di- and tetrabrominated or chlorinated derivatives thereof, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. Particular preference is given to 2,2-bis(4-hydroxyphenyl)propane (bisphenol A).

The diphenols may be used individually or in the form of any desired mixtures. The diphenols are known from the literature or obtainable by literature processes.

In a preferred embodiment the proportion of bisphenol A based on the sum of all diphenols used for production is at least 50 mol %, particularly preferably at least 75 mol %, most preferably at least 95 mol %. It is most preferable when exclusively bisphenol A is used as the diphenol in the production of component A.

The aromatic polycarbonates may be branched in a known manner, and preferably through incorporation of 0.01 to 2.0 mol %, based on the sum of the diphenols used, of trifunctional or more than trifunctional compounds, for example those having three or more phenolic groups.

The polycarbonate containing COOH end groups is preferably a linear aromatic polycarbonate, more preferably a linear aromatic polycarbonate based on bisphenol A, particularly preferably based exclusively on bisphenol A.

### Further Polymer for Producing a Copolymer

The aromatic polycarbonate containing COOH end groups may be used for producing a copolymer. This is preferably a block copolymer, more preferably a block copolymer with a vinyl (co)polymer or polyolefin.

Suitable polymers with which the aromatic polycarbonate may form a copolymer comprise at least one type of functional groups selected from ester, hydroxy, carboxy, carboxylic anhydride and epoxy groups. Polymers containing ester, hydroxy or epoxy groups are preferred. It is particularly preferable when the polymers contain epoxy groups.

In the case of an ester group as such a functional group this group may in the polymers be either a constituent of the polymer chain (polymer backbone), as is the case in a polyester, or a functional group of a monomer that is not directly involved in the growth of the polymer chain, as is the case for an acrylate polymer.

It is also possible to use mixtures of such polymers. The mixtures may in each case comprise polymers having identical functional groups or polymers having different functional groups.

In the context of the present invention polymers containing carbonate groups, i.e. esters of carbonic acid, are likewise regarded as further polymers capable of forming block copolymers with the aromatic polycarbonate provided they contain no aromatic structural units.

The further polymer is preferably selected from abovementioned functional group-containing vinyl (co)polymers and abovementioned functional group-containing polyolefins and polyesters.

The functional group-containing vinyl (co)polymers according to the invention are preferably (co)polymers of at least one monomer from the group of (meth)acrylic acid (C₁ to C₈)-alkyl ester (for example methyl methacrylate, n-butyl acrylate, tert-butyl acrylate), unsaturated carboxylic acids and carboxylic anhydrides, vinylaromatics (for example styrene, α-methylstyrene), vinyl cyanides (unsaturated nitriles such as for example acrylonitrile methacrylonitrile) and olefins (such as ethylene) and further vinyl monomers containing ester, hydroxy, carboxy, carboxylic anhydride and epoxy groups.

Epoxy groups are for example and preferably introduced when the further monomer glycidyl methacrylate is copolymerized together with the other monomer or the other monomers.

These (co)polymers are resin-like and rubber-free. (C₀)polymers of this kind are known and can be produced by free-radical polymerization, especially by emulsion, suspension, solution or bulk polymerization.

Particularly suitable vinyl polymers contain structural units derived from glycidyl methacrylate.

A particularly suitable vinyl polymer is a copolymer of methyl methacrylate and glycidyl methacrylate.

Particularly suitable vinyl polymers further include styrene-acrylonitrile-glycidyl methacrylate terpolymers and styrene-methyl methacrylate-glycidyl methacrylate terpolymers.

Suitable polyesters may be aliphatic or aromatic polyesters.

In a preferred embodiment the polyesters are aromatic, more preferably are polyalkylene terephthalates. In a particularly preferred embodiment they are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates comprise at least 80% by weight, preferably at least 90% by weight, based on the dicarboxylic acid component, of terephthalic acid radicals and at least 80% by weight, preferably at least 90% by weight, based on the diol component, of ethylene glycol and/or butane-1,4-diol radicals.

In addition to terephthalic acid radicals, the preferred aromatic polyalkylene terephthalates may comprise up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain in addition to ethylene glycol and/or butane-1,4-diol radicals up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-O-hydroxyethoxyphenyl)propane and 2,2-bis(4-hydroxy-propoxyphenyl)propane (DE-A 2 407 674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particular preference is given to aromatic polyalkylene terephthalates which have been produced solely from terephthalic acid and/or the reactive derivatives thereof (for example the dialkyl esters thereof) and ethylene glycol and/or butane-1,4-diol, and to mixtures of these polyalkylene terephthalates.

The preferably employed aromatic polyalkylene terephthalates have a viscosity number of 0.4 to 1.5 dl/g, preferably 0.5 to 1.2 dl/g, measured in phenol/o-dichlorobenzene (1:1 parts by weight) at a concentration of 0.05 g/ml according to ISO 307 at 25° C. in an Ubbelohde viscometer.

The aromatic polyalkylene terephthalates can be produced by known methods (see, for example, Kunststoff-Handbuch, volume VIII, p. 695 et seq., Carl-Hanser-Verlag, Munich 1973).

It is likewise preferable when the further polymers are functional group-containing polyolefins, preferably epoxy-containing polyolefins, particularly preferably polyolefins containing structural units derived from glycidyl methacrylate.

Polyolefins are produced by chain polymerization, for example by free-radical or anionic polymerization. Monomers used are alkenes. An alternative name for alkenes is olefins. The monomers may be polymerized individually or as a mixture of various monomers. Preferred monomers are ethylene, propylene, 1-butene, isobutene, 1-pentene, 1-heptene, 1-octene and 4-methyl-1-pentene.

The polyolefins may be semicrystalline or amorphous and linear or branched. The production of polyolefins has long been known to those skilled in the art.

The polymerization may be conducted for example at pressures of from 1 to 3000 bar and temperatures between 20° C. and 300° C., optionally with use of a catalyst system. Examples of suitable catalysts include mixtures of titanium and aluminium compounds, and metallocenes.

The number of branchings, the crystallinity and the density of the polyolefins may be varied over wide ranges by modifying the monomer composition, the type of isomers used as monomer, the polymerization conditions and the catalyst system. These measures are also familiar to those skilled in the art.

Functional groups are for example introduced into the polyolefins through copolymerization, preferably by free-radical polymerization, of vinyl monomers containing the functional group with the olefin as described hereinabove. Suitable vinyl monomers are for example glycidyl methacrylate and methyl methacrylate.

An alternative mode of production is free-radical grafting of functional group-containing vinyl monomers onto a polyolefin.

Both production processes may employ not only the functional group-containing vinyl monomers but also additionally further vinyl monomers without functional groups, such as for instance styrene.

The further polymers have average molecular weights (weight-average M_{w}, measured by GPC (gel permeation chromatography) against a polystyrene standard) of preferably 3000 to 300 000 g/mol, more preferably of 5000 to 200 000 g/mol, particularly preferably of 10 000 to 100 000 g/mol.

The solvent for the GPC measurement is selected such that it is a good solvent for the further polymer, preferably at room temperature. If solubility in the selected solvent at room temperature is observed, the GPC is performed at room temperature.

Tetrahydrofuran for example is a suitable solvent for vinyl (co)polymers such as for example copolymers of methyl methacrylate and glycidyl methacrylate, styrene-acrylonitrile-glycidyl methacrylate terpolymers and styrene-methyl methacrylate-glycidyl methacrylate terpolymers.

Suitable solvents for polyolefins containing structural units derived from glycidyl methacrylate include ortho-dichlorobenzene or 1,2-dichloroethane for example. Sufficient solubility is often brought about by an elevated temperature of for example 40° C., 60° C., 80° C., 100° C. or 120° C. In this case the GPC is performed at the temperature required for achieving a solubility sufficient for GPC.

If the polyolefin requires a temperature above 40° C. to achieve a solubility sufficient for GPC it is preferable to employ ortho-dichlorobenzene as solvent.

Production of Copolymers from the Polycarbonates According to the Invention

Copolymers containing at least one polycarbonate block, preferably block copolymers with vinyl (co)polymers or polyolefins, most preferably block copolymers with PMMA, are producible from the aromatic polycarbonates containing COOH end groups according to the invention and the above-described further polymers. The present invention further provides such copolymers.

Production of such block copolymers is preferably carried out with a process comprising the steps of:
a) melting a composition containing
   I) an aromatic polycarbonate containing COOH end groups according to the invention and
   II) a further, functional group-containing polymer according to the description in the preceding chapter
   through introduction of thermal energy and/or mechanical shear,
b) mixing and dispersing the different components of the composition with/into one another,
c) solidifying the melt by cooling,
d) pelletizing the material resulting from steps a) to c),
   wherein step (b) is carried out in a compounding machine selected from the group consisting of single-screw extruders, co-rotating or counter-rotating twin-screw extruders, planetary roller extruders, internal kneaders or co-kneaders and at a temperature of the melt of preferably 230° C. to 300° C.

### Further Components for Producing a Thermoplastic Moulding Compound

Both the aromatic polycarbonate-containing COOH end groups according to the invention themselves and block copolymers produced therefrom may be employed as a constituent of a thermoplastic moulding compound, preferably containing one or more further polymers. The block copolymers are in particular suitable for use in thermoplastic moulding compounds containing polycarbonate, preferably aromatic polycarbonate. These block copolymers are more preferably suitable for use in thermoplastic polymer blend moulding compounds containing aromatic polycarbonate and at least one further polymer having similar polarity to the polymer block which is bonded to the aromatic polycarbonate block in the block copolymer. These block copolymers are most preferably suitable for use in thermoplastic polymer blends containing aromatic polycarbonate and as a further polymer the same polymer as is bonded to the aromatic polycarbonate as a polymer block in the block copolymer.

These moulding compounds may contain further components such as polymer additives, processing auxiliaries and/or further polymeric components preferably selected from the group consisting of flame retardants, anti-drip agents, flame retardant synergists, smoke inhibitors, lubricants and demoulding agents, nucleating agents, polymeric and nonpolymeric antistats, conductivity additives, stabilizers (for example hydrolysis, heat ageing and UV stabilizers and also transesterification inhibitors), flow promoters, impact modifiers (either with or without a core-shell structure), polymeric blend partners, fillers and reinforcers and dyes and pigments.

Preferred polymeric blend partners are aromatic polycarbonate free from COOH end groups, polyesters (for example and preferably polyethylene terephthalate and polybutylene terephthalate), vinyl (co)polymers and polyolefins. These need not contain any functional groups, in contrast to the polymers used for producing copolymers. That is to say they may also be free from functional groups selected from ester, hydroxy, carboxy, carboxylic anhydride and epoxy groups. Suitable polymeric blend partners thus also include for example polystyrene, polyolefins, copolymers of ethylene and/or propylene and acrylates, styrene-acrylonitrile copolymer, styrene-methyl methacrylate copolymer and polymethyl methacrylate. These may be either rubber-free or rubber-containing. The latter applies for example to acrylonitrile-butadiene-styrene (ABS) or acrylonitrile-butyl acrylate-styrene (ASA) polymers.

The abovementioned further components are employed in a total proportion of 0% to 40% by weight, preferably 0.1% to 30% by weight, more preferably 0.1% to 10% by weight, based on the thermoplastic composition.

To achieve transparent thermoplastic compositions it is generally advantageous/technically necessary to eschew certain further components such as for example fillers and reinforcers, impact modifiers and rubber-containing blend partners or to limit their concentration and the concentration of the otherwise employed further components to markedly lower contents than specified above.

Production of Moulding Compounds Containing the Polycarbonates and/or Copolymers According to the Invention and Production of Shaped Articles from Such Moulding Compounds

The thermoplastic moulding compounds according to the invention may for example be produced by mixing together in the melt the respective constituents, i.e. the polycarbonate according to the invention and/or the copolymer according to the invention and further polymeric components, polymer additives and/or process auxiliaries (i.e. the composition) at temperatures of 220° C. to 320° C., preferably 230° C. to 300° C., particularly preferably 240° C. to 280° C., most preferably 250° C. to 270° C.

Mixing may be carried out in customary apparatuses, for example in single-screw extruders, co-rotating or counter-rotating twin-screw extruders, planetary roller extruders, internal kneaders or continuous or discontinuous co-kneaders. The compositions are melt-compounded or melt-extruded therein to form moulding compounds. In the context of the present application, this process is generally referred to as compounding or melt compounding. The term “moulding compound” is thus understood to mean the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means that, for example, some of the constituents may be introduced completely or partially via the main intake of an extruder and the remaining constituents may be introduced completely or partially later in the compounding process via a side extruder.

The moulding compounds of the invention may be used to produce shaped articles of any kind. These may be produced by injection moulding, extrusion and blow moulding processes for example. A further form of processing is the production of shaped articles by thermoforming from previously produced sheets or films.

It is also possible to meter the constituents of the composition directly into the conveying extruder of an injection moulding machine, to thus produce the moulding compound according to the invention in the conveying extruder and to effect direct processing into shaped articles by appropriate discharging of the moulding compound into an injection mould (compounding or reactive compounding injection moulding).

The present invention further relates to the use of a composition according to the invention or of a moulding compound according to the invention for producing shaped articles and furthermore also to a shaped article obtainable from a composition according to the invention or from a moulding compound according to the invention or containing such a moulding compound.

Examples of such shaped articles are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automotive sector. The compositions and moulding compounds according to the invention are also suitable for producing the following shaped articles or moulded parts: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, moulded parts for sanitation and bath equipment, protective grilles for ventilation openings and housings for garden equipment.

Further embodiments of the present invention are as follows.

1. Aromatic polycarbonate containing
A) structural units having a free COOH functionality derived from a hydroxybenzoic acid and present as end groups and
B) structural units derived from a hydroxybenzoic acid, wherein component B) is selected from at least one representative of
B1) structural units having an esterified COOH functionality derived from a hydroxybenzoic acid and present as end groups
and
B2) structural units derived from a hydroxybenzoic acid which are incorporated in the polymer chain via an ester group or acid anhydride group,
wherein the molar ratio of the amount of component A to the amount of component B is in the range 1.3 to 50.

2. Aromatic polycarbonate according to embodiment 1, characterized in that the acid number thereof is at least 0.3 mg KOH/g, determined in dichloromethane (DCM)/ethanol as solvent according to DIN EN ISO 2114, method A, 2002-6 version, by potentiometric titration with ethanolic KOH solution at room temperature.

3. Aromatic polycarbonate according to embodiment 2, characterized in that the acid number thereof is in the range from 0.5 to 10 mg KOH/g.

4. Aromatic polycarbonate according to any of the preceding embodiments, characterized in that the molar ratio of the amount of component A to the amount of component B is in the range from 1.5 to 25.

5. Aromatic polycarbonate according to any of the preceding embodiments, characterized in that the molar ratio of the amount of component A to the amount of component B is in the range from 2.0 to 5.0.

6. Aromatic polycarbonate according to any of the preceding embodiments, characterized in that the molar ratio of the amount of component B2 to the sum of the amounts of components A and B2 is <0.3.

7. Aromatic polycarbonate according to any of the preceding embodiments, characterized in that the molar ratio of the amount of component B2 to the sum of the amounts of components A and B2 is <0.2.

8. Aromatic polycarbonate according to any of the preceding embodiments, characterized in that therein the molar ratio of the amount of component A to the sum of the amounts of components A and B1 is >0.75.

9. Aromatic polycarbonate according to any of the preceding embodiments, characterized in that therein the molar ratio of the amount of component A to the sum of the amounts of components A and B1 is >0.90.

10. Aromatic polycarbonate according to any of the preceding embodiments, further containing as component C structural units derived from monophenols containing no carboxy or carboxy derivative functionalities.

11. Aromatic polycarbonate according to embodiment 10, wherein the monophenol is p-tert-butylphenol or phenol.

12. Aromatic polycarbonate according to embodiment 10 or 11, wherein component C is present in the polycarbonate in a molar proportion, based on a total of 100 mol % of the molar proportions of components A, B1, B2 and C, of 20 to 90 mol %.

13. Aromatic polycarbonate according to embodiment 10 or 11, wherein component C is present in the polycarbonate in a molar proportion, based on a total of 100 mol % of the molar proportions of components A, B1, B2 and C, of 50 to 75 mol %.

14. Aromatic polycarbonate according to any of the preceding embodiments, wherein the weight-average molecular weight M_{w}, measured by GPC at room temperature in methylene chloride using a BPA polycarbonate standard, is 5000 to 40 000 g/mol.

15. Aromatic polycarbonate according to embodiment 14, wherein the weight-average molecular weight M_{w} is 24 000 to 32 000 g/mol.

16. Aromatic polycarbonate according to embodiment 14, wherein the weight-average molecular weight M_{w} is 5000 to 25 000 g/mol.

17. Aromatic polycarbonate according to embodiment 14, wherein the weight-average molecular weight M_{w} is 8000 to 18 000 g/mol.

18. Aromatic polycarbonate according to embodiment 14, wherein the weight-average molecular weight M_{w} is 10 000 to 15 000 g/mol.

19. Process for producing an aromatic polycarbonate comprising the steps of:
(i) producing an aromatic polycarbonate containing end groups derived from a hydroxybenzoic ester by phosgenation in the phase interface process or in organic solution of aromatic diols in the presence of an ester of a hydroxybenzoic acid or a mixture of two or more esters of one or more structurally distinct hydroxybenzoic acids
as chain terminator,
wherein a temperature of 260° C. is at no point exceeded in the producing according to process step (i),
   and
(ii) thermal end group pyrolysis of the hydroxybenzoic ester-derived end groups in the product from process step (i) to eliminate an alkene
wherein in process step (ii) the product from process step (i) is pyrolysed in the temperature range 230° C. to 265° C. by supplying thermal or mechanical energy and the resulting alkene is removed from the apparatus and
wherein the residence time at the temperature in the range 230° C. to 265° C. is not less than 15 seconds and not more than 10 minutes.

20. Process according to embodiment 19, wherein the temperature in process step (ii) is 230° C. to 260° C.

21. Process according to embodiment 19, wherein the temperature in process step (ii) is 230° C. to 255° C.

22. Process according to any of embodiments 19 to 21, wherein the residence time is 20 seconds to 5 minutes.

23. Process according to any of embodiments 19 to 21, wherein the residence time is 30 seconds to 2 minutes.

24. Process according to any of embodiments 19 to 23, wherein process step (i) employs an ester of a hydroxybenzoic acid and an alcohol of general structure (1)

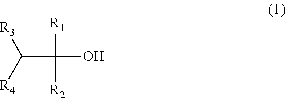

wherein R₁ and R₂ independently of one another represent hydrogen or an alkyl, aryl or alkylaryl radical having 1 to 10 carbon atoms, preferably hydrogen or an alkyl radical having 1 to 4 carbon atoms, particularly preferably hydrogen or a methyl radical, most preferably both represent a methyl radical, and
R₃ and R₄ independently of one another represent hydrogen or an alkyl, aryl or alkylaryl radical having 1 to 10 carbon atoms, preferably hydrogen or an alkyl radical having 1 to 4 carbon atoms, particularly preferably hydrogen or a methyl radical, most preferably both represent hydrogen.

25. Process according to embodiment 24, wherein the alcohol is a tertiary alcohol.

26. Process according to embodiment 24, wherein the alcohol is tert-butanol.

27. Process according to any of embodiments 19 to 26, wherein the alkene is removed by application of negative pressure.

28. Process according to any of embodiments 19 to 27, wherein in process step (ii) the product from process step (i) is melted in a compounding apparatus selected from the group comprising single-screw extruders, co-rotating or counter-rotating twin-screw extruders, planetary roller extruders, continuous or discontinuous internal kneaders and filmtruders by supplying thermal or mechanical energy and pyrolysed at a melt temperature in the range 230° C. to 260° C. and wherein the residence time of the melt in this temperature range is not less than 30 seconds and not more than 2 minutes.

29. Process according to any of embodiments 19 to 28 for producing an aromatic polycarbonate according to any of embodiments 1 to 18.

30. Polycarbonate produced by a process according to any of embodiments 19 to 28.

31. Copolymer containing structural units derived from an aromatic polycarbonate according to any of embodiments 1 to 18 or 30.

32. Copolymer according to embodiment 31 containing at least one polycarbonate block.

33. Copolymer according to embodiment 31 containing at least one polycarbonate block and at least one vinyl polymer or polyolefin block.

34. Copolymer according to embodiment 31 containing at least one polycarbonate block and at least one polymethyl methacrylate block.

35. Thermoplastic moulding compound containing a copolymer according to any of embodiments 31 to 34 or an aromatic polycarbonate according to any of embodiments 1 to 18 or embodiment 30.

36. Use of an aromatic polycarbonate according to any of embodiments 1 to 18 or 30 for producing a copolymer containing at least one polycarbonate block.

37. Use of an aromatic polycarbonate according to any of embodiments 1 to 18 or 30 for producing a block copolymer containing at least one polycarbonate block and at least one vinyl polymer or polyolefin block.

38. Process for producing a copolymer containing at least one polycarbonate block comprising the steps of
a) melting a composition containing
I) an aromatic polycarbonate according to any of embodiments 1 to 18 or 30 and
II) a further polymer containing at least one type of functional group selected from ester, hydroxy, carboxy, carboxylic anhydride and epoxy groups
   through introduction of thermal energy and/or mechanical shear,
b) mixing and dispersing the different components of the composition with/into one another,
c) solidifying the melt by cooling,
d) pelletizing the solidified polymer blend resulting from steps (a) to (c),
wherein step (b) is carried out in a compounding machine selected from the group consisting of single-screw extruders, co-rotating or counter-rotating twin-screw extruders, planetary roller extruders, internal kneaders or co-kneaders and at a temperature of the melt of 230° C. to 300° C.

39. Process according to embodiment 38, wherein component II) is a vinyl polymer or polyolefin containing structural units derived from glycidyl methacrylate.

40. Shaped article containing a copolymer obtainable in a process according to embodiment 38 or 39 or a moulding compound according to the embodiment 35.

### EXAMPLES

### Production of Polycarbonate Precursor (PC-1)

Bisphenol A was subjected to the polycondensation reaction with phosgene in the presence of a chain terminator mixture consisting of p-tert-butylphenol and tert-butyl 4-hydroxybenzoate in a mixture of methylene chloride and chlorobenzene as solvent in the interfacial process in a continuously operated laboratory reactor.

In the context of this synthesis 72.2 g/h of gaseous phosgene were dissolved in 959 g/h of organic solvent mixture composed of 50% by weight methylene chloride and 50% by weight chlorobenzene at −7° C. The thus-produced phosgene solution was contacted with 907 g/h of a 15% by weight aqueous alkaline bisphenol A solution temperature-controlled to 30° C. To this end the alkaline bisphenol A solution was pressed through a stainless steel filter having a pore size of 90 μm in the phosgene solution and thus dispersed therein. The bisphenol A solution employed 2 mol of NaOH per 1 mol of bisphenol A. The reaction mixture was reacted until complete reaction of the phosgene in a Fink HMR040 mixing pump temperature-controlled to 25° C. Thereafter, 4.11 g/h of a mixture of 50 mol % of p-tert-butylphenol and 50 mol % tert-butyl-4-hydroxybenzoate were added as chain terminator, namely in the form of a 3% by weight solution in the solvent mixture composed of 50% by weight methylene chloride and 50% by weight chlorobenzene.

The thus-obtained reaction mixture was further reacted with 66.52 g/h of 32% by weight aqueous sodium hydroxide solution in a second Fink HMR040 mixing pump temperature-controlled to 25° C. Downstream thereof were two stirred tanks run in flooded mode and fitted with baffles, each with a 600 second residence time and each followed by a respective gear pump, said pumps serving for both conveying of the reaction mixture and for further dispersing. After the first pump, i.e. upstream of the second stirred tank, 0.679 g/h of a 10% by weight solution of N-ethylpiperidine in chlorobenzene were added as catalyst. At the end of the reaction the pH was about 11.5. In a phase separation vessel the organic phase was separated from the aqueous phase of the biphasic reaction mixture and the organic phase was washed with a 0.1% by weight aqueous HCl solution to remove the catalyst.

This was further followed by washing with demineralized water to remove the salt residues. The polymer solution washed in this way was precipitated in organic solvent and dried overnight in a vacuum oven at 120° C.

### Production of Polycarbonates According to the Invention by End Group Pyrolysis of the Polycarbonate Precursor PC-1

Liberation of the COOH end groups by thermal end group pyrolysis of the polycarbonate precursor PC-1 produced according to the above-described process through elimination of the protective group in the form of isobutylene gas was carried out in a continuous Process 11 twin-screw extruder (Thermofischer Scientific, Karlsruhe, Germany) with a screw configuration having three mixing zones and a length to diameter (L/D) ratio of 40. The different inventive polycarbonate examples and comparative examples were carried out at different melt temperatures in the range from 227° C. to 288° C., measured via a thermocouple installed close to the die outlet in the last barrel element of the extruder. The melt temperature resulted from introduction of mechanical energy through the kneading elements and introduction of thermal energy through the heating of the extruder barrel. The extruder barrel is divided into eight separate and independently heatable zones. The three kneading zones were in the transition between heating zones 3 and 4, in the heating zone 5 and in the transition between heating zones 6 and 7. The raw material intake was in heating zone 1. Moreover, the outlet die is heatable separately. To adjust the different melt temperatures which were detected via the thermocouple installed close to the die outlet in the last barrel element of the extruder the barrel temperatures in the barrel zones and the die temperature were temperature-controlled to different temperatures (see table 1). The first barrel (raw material intake zone) was in all cases unheated, zone 2 was in all cases heated to a target temperature of 70° C. and zones 4 to 8 were in all cases heated to the same respective target temperature according to table 1. In all cases the same polycarbonate precursor (PC-1) was used as the input raw material. In all cases the extruder was operated with a throughput of about 300 g/h and at a speed of 175 min⁻¹. By applying a negative pressure of about 100 mbar (absolute) the isobutylene gas liberated in the extruder under these process conditions was continuously withdrawn from the extruder via a vent dome in the penultimate (seventh) heating zone. In all cases these process conditions resulted in a residence time of the polycarbonate in the extruder of about 70 seconds. The barrel temperatures used in the extruder heating zones for the distinctly produced inventive polycarbonates and comparative polycarbonates and the melt temperatures measured by the thermocouple installed close to the die outlet in the last barrel element of the extruder are apparent from table 1.

TABLE 1
Set target temperatures in the different heating zones of the barrel
and at the outlet die of the twin-screw extruder and melt temperature
measured close to the die outlet in the production of the inventive
polycarbonates and comparative polycarbonates

| | Heating | Heating | Die | Melt |
|---|---|---|---|---|
| Polycarbonate | zone 3 | zones 4-8 | temperature | temperature |
| [° C.] | [° C.] | [° C.] | [° C.] | [° C.] |
| PC-1* | Precursor | Precursor | Precursor | Precursor |
| PC-2* | 160 | 220 | 235 | 227 |
| PC-3 | 190 | 240 | 240 | 231 |
| PC-4 | 160 | 260 | 260 | 252 |
| PC-5* | 160 | 280 | 280 | 270 |
| PC-6* | 190 | 290 | 290 | 274 |
| PC-7* | 160 | 300 | 300 | 288 |

Polycarbonates marked with an * are noninventive examples.

### Structural Characterization of the Polycarbonates

The molecular weight of the polycarbonates was determined by gel permeation chromatography (GPC) in methylene chloride at room temperature with BPA polycarbonate as the calibration standard. An FTIR detector was employed at a wavelength selective for BPA polycarbonate of 1775 cm⁻¹.

The analysis of the polycarbonates in respect of the content of structural units according to components A, B1, B2-a, B2-b and C was carried out by 1H NMR spectroscopy in deuterated chloroform as solvent at room temperature (see table 2).

The integrated signal intensity of the respective NMR signals divided by the number of protons responsible for the signal is proportional to the molar content of the respective structural unit. The corresponding ratios of the thus-normalized signal intensities were thus used to determine the molar ratios of the corresponding structural units according to the various features for the inventive polycarbonates.

The acid number of the polycarbonates was determined in dichloromethane (DCM)/ethanol as solvent according to DIN EN ISO 2114, method A, 2002-6 version, by potentiometric titration with ethanolic KOH solution at room temperature. To this end the polycarbonate to be investigated was dissolved in a concentration of 10 g/L in 50 mL of dichloromethane at room temperature. 5 mL of ethanol were added to the sample solution before the potentiometric titration with 0.1 N ethanolic KOH.

The thus-determined structural features of the produced polycarbonates are summarized in table 2.

TABLE 2
Results of structural characterization of produced polycarbonates

| Trait | PC-1* | PC-2* | PC-3 | PC-4 | PC-5* | PC-6* | PC-7* |
|---|---|---|---|---|---|---|---|
| M_{w} [kg/mol] | 27.0 | n.m. | 23.6 | 24.8 | n.m. | n.m. | n.m. |
| Mₙ [kg/mol] | 15.8 | n.m. | 12.2 | 12.7 | n.m. | n.m. | n.m. |
| Acid number [mg KOH/g] | <0.1 | 1.5 | 3.0 | 2.3 | 1.3 | <0.1 | <0.1 |
| Signal intensity (8.14 ppm) = A | 0 | 1.52 | 1.87 | 2.25 | 1.24 | 0 | 0 |
| Signal intensity (8.05 ppm) = B1 | 2.84 | 1.28 | 0.54 | 0.04 | 0.06 | 0 | 0.09 |
| Signal intensity (8.26 ppm) = B2-a | 0 | 0.05 | 0.26 | 0.25 | 0.92 | 2.68 | 2.26 |
| Signal intensity (8.22 ppm) = B2-b | 0 | 0.03 | 0.14 | 0.20 | 0.39 | 0 | 0 |
| Signal intensity (1.32 ppm) = C | 14.89 | 15.77 | 15.08 | 15.63 | 15.50 | 14.42 | 14.75 |
| A/B | 0 | 1.1 | 2.0 | 4.7 | 0.9 | 0 | 0 |
| B2/(A + B2) | — | 0.05 | 0.18 | 0.16 | 0.51 | 1 | 1 |
| A/(A + B1) | 0 | 0.54 | 0.78 | 0.98 | 0.95 | — | 0 |
| C/(A + B + C) | 0.54 | 0.55 | 0.54 | 0.56 | 0.57 | 0.54 | 0.58 |

Polycarbonates marked with an * are noninventive examples.
n.m. = not measured

It is apparent from the data in table 2 in conjunction with the process parameters in table 1 that the structure of the produced polycarbonates are surprisingly strongly dependent on the thermal conditions (specifically the melt temperature) in the end group pyrolysis step (ii). Polycarbonates having a high A/B ratio are obtained in a relatively narrow melt temperature range ((PC-3) and (PC-4)) while both lower melt temperatures of for example 227° C. (PC-2*) and higher melt temperatures of 270° C. (PC-5*), 274° C. (PC-6*) and 288° C. (PC-7*) as well as the product obtained directly in process step (i), i.e. without an end group pyrolysis process step (ii), (PC-1*) result in markedly lower A/B ratios. PC-4 shows an A/B ratio which is further improved over PC-3. PC-4 also shows an A/(A+B1) ratio which is further improved over PC-3 as a measure of the degree of desired elimination of isobutylene from the tert-butyl ester protecting group to liberate terminal COOH groups. The B2/(A+B2) ratio as a measure of the degree of conversion of intermediately formed COOH end groups in undesired subsequent transesterification reactions is approximately the same for PC-3 and PC-4.

Production of Moulding Compounds from the Polycarbonates According to the Invention

The inventive polycarbonates and comparative polycarbonates were used to produce PC/PMMA moulding compounds via a reactive extrusion process. To this end the polycarbonates were initially ground into powder and premixed with a methyl methacrylate-glycidyl methacrylate copolymer (PMMA-GMA) likewise ground into a powder in a ratio of 80% by weight of the respective polycarbonate to 20% by weight of the PMMA-GMA to afford a homogeneous powder mixture. The PMMA-GMA was a random methyl methacrylate-glycidyl methacrylate copolymer having a content of glycidyl methacrylate-derived structural units of 1.0% by weight produced by free-radical polymerization and having a weight-average molecular weight M_{w} of 60 000 g/mol measured by gel permeation chromatography at room temperature in tetrahydrofuran as solvent against a polystyrene calibration standard. The epoxy equivalent of this PMMA-GMA copolymer was determined as 0.32% by weight in dichloromethane at room temperature according to DIN EN 1877-1 (12-2000 version).

For specific adjustment of different A/B ratios mixtures of an inventive polycarbonate (PC-8) and a noninventive polycarbonate (PC-6*) with different mixing ratios of these two polycarbonates were also additionally employed as the polycarbonate component for producing comparative PC/PMMA moulding compounds PC/PMMA-4* to PC/PMMA-6*.

Polycarbonate PC-8 was likewise obtained from the precursor PC-1 by thermal end group pyrolysis. PC-8 has an acid number determined in dichloromethane (DCM)/ethanol as solvent according to DIN EN ISO 2114, method A, 2002-6 version, by potentiometric titration with ethanolic KOH solution at room temperature of 2.4 mg KOH/g. ¹H NMR spectroscopy was used to determine the ratio A/B as 1.8, the ratio B2/(A+B2) as 0.28, the ratio B1/(A+B1) as 0.85 and the ratio C/(A+B+C) as 0.55.

The thermoplastic PC/PMMA moulding compounds composed of the compositions shown in table 3 were compounded in a Process 11 continuous twin-screw extruder (Thermofischer Scientific, Karlsruhe, Germany) having a screw configuration comprising two mixing zones at a melt temperature of 260° C., a throughput of about 300 g/h, a speed of 125 min⁻¹ and an absolute pressure of 100 mbar. These conditions resulted in a residence time of about 90 seconds. After discharging through a die plate the melt strand was cooled, thus solidified and subsequently pelletized. For the compounding operations the powder mixtures of the PC and the PMMA component were metered into the feed zone of the twin-screw extruder via a volumetric metering means.

Production of Shaped Articles from the Moulding Compounds Containing Polycarbonates According to the Invention and Technical Evaluation Thereof

The thermoplastic PC/PMMA moulding compounds produced from the compositions according to table 3 were used to produce round plates having a diameter of 25 mm and a thickness of 1 mm at a temperature of 260° C., a pressure of 100 bar and a total pressing time of 4 min in a Polystat 200 laboratory thermal press from Servitec Maschinenservice GmbH (Wustermark, Germany).

The transparency of the thus-produced shaped articles and homogeneity thereof was initially assessed by visual means. The corresponding wavelength-dependent total transmittances were further determined according to DIN 5033-7 (2014) and used to calculate the transmittance value Y(D65, 10°) with light type D65 and an observer angle of 10° according to DIN EN ISO 11664-3 (2013).

The ductility of the moulding compounds was likewise evaluated on these thermally pressed round plates having a diameter of 25 mm and a thickness of 1 mm at room temperature in an impact test. Measurements were carried out with a custom-built drop impact tester (dropped mass 1.86 kg, support diameter 15 mm, mandrel diameter (hemispherical) 7 mm). The drop height of the dropped mass was systematically varied and the maximum height at which the test specimen is not penetrated/shows no damage and the maximum drop height at which the test specimen shows ductile fracture with stable crack propagation were determined.

The data in table 3 show that only the inventive polycarbonate PC-3 made it possible to produce a PC/PMMA moulding compound processable into a homogeneous transparent shaped article having a high transmittance. This moulding compound also has a good ductility at room temperature. The noninventive comparative polycarbonate PC-6* that was end group-pyrolysed at a higher melt temperature did not allow a transparent shaped article to be realized. The noninventive comparative polycarbonate PC-1* from process step (i) likewise did not allow realization of a homogeneously transparent shaped article. The PC/PMMA moulding compounds produced with this polycarbonate resulted in milky, streaky shaped articles. The moulding compounds PC/PMMA-4* to PC/PMMA-6* produced with polycarbonate mixtures for specific variation of the A/B ratio in the range up to 0.9 did not make it possible to achieve transparent shaped articles with high light transmittance (i.e. transilluminability) either.

TABLE 3
PC/PMMA moulding compounds

| | PC/ | PC/ | PC/ | PC/ | PC/ | PC/ |
|---|---|---|---|---|---|---|
| | PMMA-1* | PMMA-2 | PMMA-3* | PMMA-4* | PMMA-5* | PMMA-6* |
| Composition | | | | | | |
| PC-1* | 80 | | | | | |
| PC-3 | | 80 | | | | |
| PC-6* | | | 80 | 20 | 40 | 60 |
| PC-8 | | | | 60 | 40 | 20 |
| PMMA-GMA | 20 | 20 | 20 | 20 | 20 | 20 |
| Feature of PC raw | | | | | | |
| material mixture | | | | | | |
| Acid number | | | | 1.8 | 1.2 | 0.6 |
| [mg KOH/g] | | | | | | |
| A/B | | | | 0.9 | 0.5 | 0.2 |
| B2/(A + B2) | | | | 0.47 | 0.66 | 0.83 |
| B1/(A + B1) | | | | 0.85 | 0.85 | 0.85 |
| C/(A + B + C) | | | | 0.55 | 0.55 | 0.55 |
| Properties | | | | | | |
| Visual assessment | Inhomo- | Homo- | Homo- | Homo- | Homo- | Homo- |
| | geneously | geneously | geneously | geneous, | geneous, | geneously |
| | milky, | transparent | opaque | cloudy | milky, | opaque |
| | streaky | | | | cloudy | |
| Transmittance | | 83 | | | | |
| Y(D65, 10°) [%] | | | | | | |
| Ductility: | | 20 | | | | |
| No damage up to a | | | | | | |
| drop height of [cm] | | | | | | |
| Ductility: | | 40 | | | | |
| Ductile fracture | | | | | | |
| with stable crack | | | | | | |
| propagation up to a | | | | | | |
| drop height of | | | | | | |
| [cm] | | | | | | |

Polycarbonates marked with an * are noninventive examples.

1: Aromatic polycarbonate containing
A) structural units having a free COOH functionality derived from a hydroxybenzoic acid and present as end groups and
B) structural units derived from a hydroxybenzoic acid,
wherein component B) is selected from at least one representative of
B1) structural units having an esterified COOH functionality derived from a hydroxybenzoic acid and present as end groups
and
B2) structural units derived from a hydroxybenzoic acid which are incorporated in the polymer chain via an ester group or acid anhydride group,
wherein the molar ratio of the amount of component A to the amount of component B is in the range 1.3 to 50.

2: Aromatic polycarbonate according to claim 1, wherein the polycarbonate is characterized by an acid number in the range from 0.5 to 10 mg potassium hydroxide (KOH)/g, determined in dichloromethane (DCM)/ethanol as solvent according to DIN EN ISO 2114, method A, 2002-6 version, by potentiometric titration with ethanolic KOH solution at room temperature.

3: Aromatic polycarbonate according to claim 1, characterized in that the molar ratio of the amount of component B2 to the sum of the amounts of components A and B2 is <0.3.

4: Aromatic polycarbonate according to claim 1, characterized in that therein the molar ratio of the amount of component A to the sum of the amounts of components A and B1 is >0.75.

5: Aromatic polycarbonate according to claim 1, further containing as component C structural units derived from monophenols containing no carboxy or carboxy derivative functionalities, wherein component C is present in the polycarbonate in a molar proportion, based on a total of 100 mol % of the molar proportions of components A, B1, B2 and C, of 20 to 90 mol %.

6: Process for producing an aromatic polycarbonate comprising the steps of:
(i) producing an aromatic polycarbonate containing end groups derived from a hydroxybenzoic ester by phosgenation in the phase interface process or in organic solution of aromatic diols in the presence of an ester of a hydroxybenzoic acid or a mixture of two or more esters of one or more structurally distinct hydroxybenzoic acids as chain terminator,
wherein a temperature of 260° C. is at no point exceeded in the producing according to process step (i),
and
(ii) thermal end group pyrolysis of the hydroxybenzoic ester-derived end groups in the product from process step (i) to eliminate an alkene
wherein in process step (ii) the product from process step (i) is pyrolyzed in the temperature range 230° C. to 265° C. by supplying thermal or mechanical energy and the resulting alkene is removed from the apparatus and wherein the residence time at the temperature in the range 230° C. to 265° C. is not less than 15 seconds and not more than 10 minutes.

7: Process according to claim 6, wherein process step (i) employs an ester of a hydroxybenzoic acid and an alcohol of general structure (1) 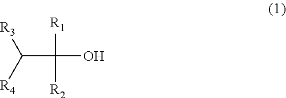
wherein R₁, R₂, R₃ and R₄ independently of one another represent hydrogen or an alkyl, aryl or alkylaryl radical having 1 to 10 carbon atoms.

8: Process according to claim 6, wherein in process step (ii) the product from process step (i) is melted in a compounding apparatus selected from the group comprising single-screw extruders, co-rotating or counter-rotating twin-screw extruders, planetary roller extruders, continuous or discontinuous internal kneaders and filmtruders by supplying thermal or mechanical energy and pyrolyzed at a melt temperature in the temperature range 230° C. to 260° C. and wherein the residence time of the melt in this temperature range is not less than 30 seconds and not more than 2 minutes.

9: Process according to claim 6 for producing an aromatic polycarbonate.

10: Copolymer containing structural units derived from an aromatic polycarbonate according to claim 1.

11: Thermoplastic moulding compound containing a copolymer according to claim 10.

12: Use of an aromatic polycarbonate according to claim 1 for producing a copolymer containing at least one polycarbonate block and at least one vinyl polymer or polyolefin block.

13: Process for producing a copolymer containing at least one polycarbonate block comprising the steps of
a) melting a composition containing
I) an aromatic polycarbonate according to claim 1 and
II) a further polymer containing at least one type of functional group selected from ester, hydroxy, carboxy, carboxylic anhydride and epoxy groups through introduction of thermal energy and/or mechanical shear,
b) mixing and dispersing the different components of the composition with/into one another,
c) solidifying the melt by cooling,
d) pelletizing the solidified polymer blend resulting from steps (a) to (c),
wherein step (b) is carried out in a compounding machine selected from the group consisting of single-screw extruders, co-rotating or counter-rotating twin-screw extruders, planetary roller extruders, internal kneaders or co-kneaders and at a temperature of the melt of 230° C. to 300° C.

14: Process according to claim 13, wherein component II) is a vinyl polymer or polyolefin containing structural units derived from glycidyl methacrylate.

15: Shaped article containing a copolymer obtained in the process according to claim 13.
